(19) United States
(12) Patent Application Publication
(10) Pub. No.: US 2019/0006687 A1
(43) Pub. Date: Jan. 3, 2019

(54) METHOD OF AND APPARATUS FOR ACTIVATING FUEL CELL

(71) Applicant: HONDA MOTOR CO., LTD., Tokyo (JP)

(72) Inventors: Hodaka Tsuge, Hagagun (JP); Ayumi Mizuno, Hagagun (JP); Takashi Kato, Hagagun (JP); Tadaaki Yamada, Hagagun (JP); Koichiro Sato, Hagagun (JP); Yo Shimomura, Hagagun (JP)

(21) Appl. No.: 16/016,699

(22) Filed: Jun. 25, 2018

(30) Foreign Application Priority Data
Jun. 29, 2017 (JP) 2017-127368

(51) Int. Cl. H01M 8/04225; H01M 8/04119; H01M 8/04029; H01M 8/04701; H01M 8/04828; H01M 8/04858; H01M 8/04302

(52) U.S. Cl. CPC H01M 8/04225; H01M 8/04126; H01M 8/04029; H01M 2008/1095; H01M 8/04828; H01M 8/04873; H01M 8/04302; H01M 8/04701

(57) ABSTRACT

In a method of activating a fuel cell, after a voltage application step is performed, a humidifying step is performed. In the voltage application step, a hydrogen gas is supplied to an anode, and an inert gas is supplied to a cathode. In the meanwhile, cyclic voltage which is increased and decreased within a predetermined range is applied to the fuel cell. In the humidifying step, in a state where application of the voltage is stopped, a humidified gas containing water vapor is supplied to at least one of the anode and the cathode.

### CROSS-REFERENCE TO RELATED APPLICATION

This application is based upon and claims the benefit of priority from Japanese Patent Application No. 2017-127368 filed on Jun. 29, 2017, the contents of which are incorporated herein by reference.

### BACKGROUND OF THE INVENTION

### Field of the Invention

The present invention relates to a method of activating a fuel cell including an electrolyte membrane of solid polymer, an anode provided on one surface of the electrolyte membrane, and a cathode provided on the other surface of the electrolyte membrane. Further, the present invention relates to an apparatus for activating the fuel cell.

### Description of the Related Art

As a method of activating a fuel cell, for example, Japanese Laid-Open Patent Publication No. 2008-235093 proposes to supply a humidified gas to at least one of an anode and a cathode. Further, for example, Japanese Laid-Open Patent Publication No. 2009-146876 proposes to supply the humidified gas in the same manner as described above, and thereafter, supply hydrogen to the anode, supply nitrogen to the cathode, and apply cyclic voltage which changes in a cyclic manner in a range between 0 and 3 V to the fuel cell.

### SUMMARY OF THE INVENTION

However, it is difficult to sufficiently activate a fuel cell by the method only supplying the hot humidified gas as described above, and applying voltage after supplying the hot humidified gas as described above.

A main object of the present invention is to provide a method of activating a fuel cell which makes it possible to activate the fuel cell effectively.

Another object of the present invention is to provide an apparatus for activating a fuel cell which makes it possible to activate the fuel cell effectively.

According to an embodiment of the present invention, a method of activating a fuel cell is provided. The fuel cell includes an electrolyte membrane of solid polymer, an anode provided on one surface of the electrolyte membrane, and a cathode provided on another surface of the electrolyte membrane, and the method includes a voltage application step of applying cyclic voltage which is increased and decreased within a predetermined range, to the fuel cell while supplying a hydrogen gas to the anode and supplying an inert gas to the cathode and a humidifying step of supplying a humidified gas containing water vapor to at least one of the anode and the cathode after the voltage application step, in a state where application of the voltage is stopped.

In the method of activating the fuel cell, in the voltage application step, materials adhered to the surface of the electrode catalyst contained in the anode and the cathode are removed, and thereafter, the humidification step is performed. In this manner, since it is possible to suitably supply water to the surface of the electrode catalyst without being obstructed by adhered materials, it is possible to effectively activate the fuel cell.

In the method of activating the fuel cell, preferably, in the humidifying step, a dew point of the humidified gas may be regulated to become higher than a temperature of the fuel cell. In this case, in the humidifying step, it is possible to easily condense the water vapor contained in the humidified gas, inside the fuel cell. Thus, it is possible to suitably supply water to the electrolyte membrane and/or the electrolyte catalyst, and effectively activate the fuel cell to a greater extent.

In the method of activating the fuel cell, preferably, a temperature of the fuel cell in the humidifying step may be regulated to become equal to or lower than a temperature of the fuel cell in the voltage application step. In this case, there is no need to regulate the dew point of the gases supplied to the anode and the cathode highly accurately. In the voltage application step, water condensation does not occur easily inside the fuel cell, and in the humidifying step, water condensation occurs easily inside the fuel cell. Therefore, it is possible to suppress the voltage from being non-uniformly applied to the entire fuel cell in the voltage application step, and it is possible to suitably supply water to the electrode catalyst and the electrolyte membrane in the humidifying step. As a result, it is possible to effectively activate the fuel cell to a greater extent.

In the method of activating the fuel cell, preferably, the temperature of the fuel cell may be regulated by supplying a heat transmission medium having a regulated temperature, to a coolant flow field provided for the fuel cell. In this case, using the existing structure of the fuel cell, it is possible to efficiently and easily regulate the temperature of the entire fuel cell.

Preferably, the method of activating the fuel cell includes at least one of the steps of supplying the humidified gas having same dew point as that of the hydrogen gas supplied to the anode in the voltage application step, to the anode in the humidifying step and supplying the humidified gas having same dew point as that of the inert gas supplied to the cathode in the voltage application step, to the cathode in the humidifying step. It should be noted that the meaning of the expression the “same” dew point herein may include “substantially the same” dew point. In this case, since there is no need to provide the step of regulating the dew point of the gas supplied to at least one of the anode and the cathode, between the voltage application step and the humidifying step, it is possible to efficiently activate the fuel cell.

In the method of activating the fuel cell, preferably, in the humidifying step, as the humidified gases, the hydrogen gas may be supplied to the anode and the inert gas may be supplied to the cathode. In this case, since the same gases can be used in both of the voltage application step and the humidifying step, it is possible to achieve improvement in the efficiency of activating the stack to a greater extent. Further, also in the humidifying step, it is possible to produce a potential difference between the anode to which the hydrogen gas is supplied and the cathode to which the inert gas is supplied. Thus, it becomes possible to effectively activate the fuel cell to a greater extent.

In the method of activating the fuel cell, preferably, in the humidifying step, as the humidified gases, both of the hydrogen gas and the inert gas may be supplied to the anode. In this case, in the humidifying step, it is possible to produce a potential difference between the anode and the cathode. Since the inert gas is mixed, it is possible to reduce the quantity of the hydrogen gas supplied to the anode by the amount of the inert gas. As a result, it is possible to effectively activate the fuel cell, and reduce the cost required for activation of the fuel cell.

In the method of activating the fuel cell, preferably, the fuel cell may include a stack of a plurality of power generation cells stacked together. In this case, it is possible to activate the plurality of power generation cells together to achieve improvement in the efficiency, and effectively activate the fuel cell which is put into practical use.

Further, an apparatus for activating a fuel cell to which the activation method of the above described fuel cell is applied is also included in the present invention. That is, another embodiment of the present invention provides an apparatus for activating a fuel cell, and the fuel cell includes an electrolyte membrane of solid polymer, an anode provided on one surface of the electrolyte membrane, and a cathode provided on another surface of the electrolyte membrane, and the apparatus includes a gas supply unit configured to supply an anode gas to the anode, and supply a cathode gas to the cathode, and a voltage application unit configured to apply cyclic voltage which is increased and decreased within a predetermined range, to the fuel cell, wherein the gas supply unit is configured to supply a hydrogen gas as the anode gas, and supply an inert gas as the cathode gas, in a voltage application period in which the voltage is applied by the voltage application unit and configured to supply a humidified gas containing water vapor as at least one of the anode gas and the cathode gas after the voltage application period, in a state where application of the voltage is stopped.

In the apparatus for activating the fuel cell, it is possible to remove materials adhered to the surface of the electrode catalyst in the voltage application period. Therefore, by supplying the humidified gas after the voltage application period, it is possible to supply water to the surface of the electrode catalyst. As a result, it is possible to effectively activate the fuel cell.

In the apparatus for activating the fuel cell, preferably, the gas supply unit may be configured to supply the humidified gas having a dew point which is higher than a temperature of the fuel cell. In this case, since it is possible to easily condense water vapor contained in the humidified gas inside the fuel cell, it is possible to suitably supply water to the electrolyte membrane and the electrode catalyst, and effectively activate fuel cell to a greater extent.

Preferably, the apparatus for activating the fuel cell may further include a temperature regulating unit configured to regulate a temperature of the fuel cell, and the temperature regulating unit may be configured to regulate a temperature of the fuel cell after the voltage application period to become equal to or lower than a temperature of the fuel cell in the voltage application period. In this case, since the temperature regulating unit regulates the temperature of the fuel cell, in the voltage application period, water condensation does not occur easily, and it is possible to prevent the voltage from being applied non-uniformly over the entire fuel cell. In contrast, while supplying the humidified gas after the voltage application period, water condensation occurs easily, and it is possible to suitably supply the water to the electrolyte membrane and the electrode catalyst. As a result, there is no need to regulate the dew points of the anode gas and the cathode gas by the gas supply unit highly accurately, and it is possible to activate the fuel cell to a greater extent.

In the apparatus for activating the fuel cell, preferably, the temperature regulating unit may be configured to regulate the temperature of the fuel cell by supplying a heat transmission medium having a regulated temperature, to a coolant flow field provided for the fuel cell. In this case, using the existing structure of the fuel cell, it is possible to effectively and easily regulate the temperature of the entire fuel cell.

In the apparatus for activating the fuel cell, preferably, the gas supply unit may be configured to perform at least one of supplying the humidified gas having same dew point as that of the hydrogen gas supplied to the anode in the voltage application period, to the anode after the voltage application period and supplying the humidified gas having same dew point as that of the inert gas supplied to the cathode in the voltage application period, to the cathode after the voltage application period. In this case, since there is no need to regulate the dew point of the gas supplied to the fuel cell by the gas supply unit during the voltage application period and after the voltage application period, it is possible to efficiently activate the fuel cell.

In the apparatus for activating the fuel cell, preferably, the gas supply unit may be configured to supply the hydrogen gas to the anode, and supply the inert gas to the cathode, as the humidified gases. In this case, since the same gases can be used in the voltage application period, and after the voltage application period, it is possible to improve the efficiency in activating the fuel cell. Further, since the potential difference is produced between the anode and the cathode to which the humidified gas has been supplied, it is possible to effectively activate the fuel cell to a greater extent.

In the apparatus for activating the fuel cell, preferably, the gas supply unit may be configured to supply both of the hydrogen gas and the inert gas to the anode, as the humidified gases. In this case, by supplying the humidified gas after the voltage application period, it is possible to produce a potential difference between the anode and the cathode. Since the inert gas is mixed, it is possible to reduce the quantity of the hydrogen gas supplied to the anode by the amount of the inert gas. As a result, it is possible to effectively activate the fuel cell, and reduce the cost required for activation of the fuel cell.

In the apparatus for activating the fuel cell, preferably, the fuel cell may include a stack of a plurality of power generation cells stacked together. In this case, it is possible to activate the plurality of power generation cells together to achieve improvement in the efficiency, and effectively activate the fuel cell which is put into practical use.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a diagram schematically showing structure of an apparatus for activating a fuel cell according to an embodiment of the present invention;

FIG. 2A is a table showing periods in which a humidifying step was performed and voltage ratios, for stacks of embodiment examples 1-1 to 1-7 and a comparative example 1;

FIG. 2B is a graph where the period in which the humidifying step was performed in FIG. 2A is indicated by a horizontal axis, and the voltage ratio in FIG. 2A is indicated by a vertical axis;

FIG. 3 is a table showing periods in which a voltage application step was performed, periods in which a humidifying step was performed, and voltage ratios, for stacks of embodiment examples 2-1 to 2-4 and a comparative example 2;

FIG. 4 is a table showing stack temperatures, dew points of an anode gas, dew points of a cathode gas, intra-stack relative humidities in each of the voltage application step and the humidifying step, and voltage ratios, for stacks of embodiment examples 3-1 to 3-9 and a comparative example 3; and

FIG. 5 is a table showing types and flow rates of each of an anode gas and a cathode gas in the humidifying step and voltage ratios, for stacks of embodiment examples 4-1 to 4-4.

### DESCRIPTION OF THE PREFERRED EMBODIMENTS

Preferred embodiments of an activation method and an activation apparatus for a fuel cell according to the present invention will be described in detail with reference to the accompanying drawings.

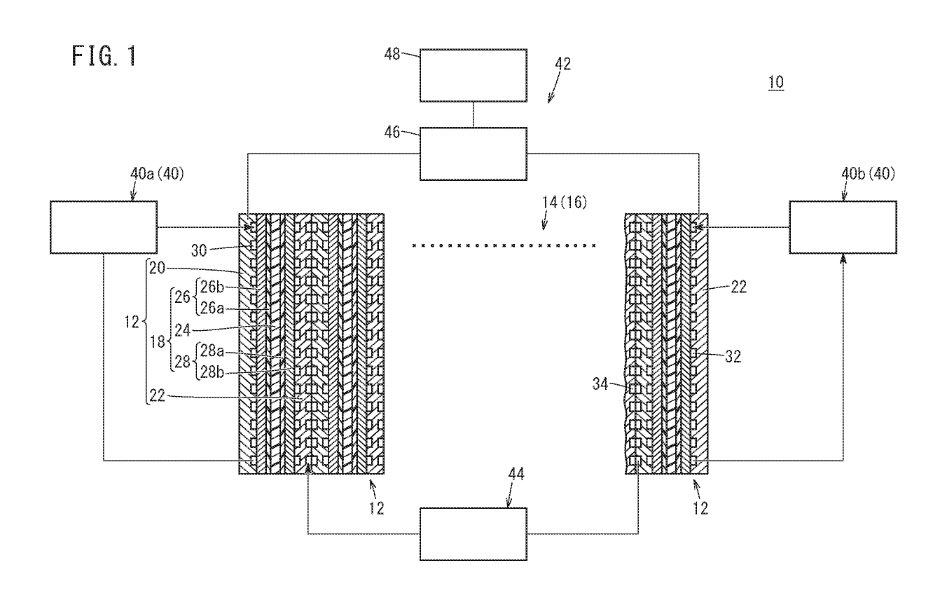

As shown in FIG. 1, an activation apparatus for a fuel cell according to an embodiment of the present invention (hereinafter simply also referred to as the activation apparatus) 10 activates a fuel cell 16 which comprises a stack 14 formed by stacking a plurality of power generation cells 12 (unit fuel cells). It should be noted that the activation apparatus 10 is not limited to the form of the stack 14. A fuel cell (not shown) comprising a single power generation cell 12 can be activated in the same manner.

The power generation cell 12 is formed by sandwiching a membrane electrode assembly (MEA) 18 between a first separator 20 and a second separator 22. For example, the MEA 18 includes an electrolyte membrane 24, an anode 26 provided on one surface of the electrolyte membrane 24, and a cathode 28 provided on another surface of the electrolyte membrane 24. The electrolyte membrane 24 is a thin membrane of solid polymer such as perfluorosulfonic acid.

The anode 26 is made of porous material including a first electrode catalyst layer 26a facing one surface of the electrolyte membrane 24, and a first gas diffusion layer 26b stacked on the first electrode catalyst layer 26a. The cathode 28 is made of porous material including a second electrode catalyst layer 28a facing the other surface of the electrolyte membrane 24, and a second gas diffusion layer 28b stacked on the second electrode catalyst layer 28a.

Each of the first electrode catalyst layer 26a and the second electrode catalyst layer 28a includes catalyst particles (electrode catalyst) supporting catalyst metal of platinum, etc. on a catalyst support of carbon such as carbon black, and an ion conductive polymer binder. It should be noted that the electrode catalyst may only comprise catalyst metal such as platinum black, and the electrode catalyst may not include the catalyst support.

In the case where the electrode catalyst comprises platinum, for example, the following electrode reaction occurs on the surface of the electrode catalyst: 2Pt+H₂O+½O₂+e⁻→2Pt(OH⁻), Pt (OH⁻)+H₃O⁺→Pt+2H₂O Therefore, by supplying water to the surface of the electrode catalyst, it is possible to facilitate reaction which occurs in the surface of the electrode catalyst.

For example, each of the first gas diffusion layer 26b and the second gas diffusion layer 28b comprises a carbon paper, carbon cloth, etc. The first gas diffusion layer 26b is placed to face the first separator 20, and the second gas diffusion layer 28b is placed to face the second separator 22. For example, carbon separators are used as the first separator 20 and the second separator 22. Alternatively, metal separators may be used as the first separator 20 and the second separator 22.

The first separator 20 has a fuel gas flow field 30 on its surface facing the first gas diffusion layer 26b. The fuel gas flow field 30 is connected to a fuel gas supply passage (not shown) for supplying a fuel gas such as a hydrogen-containing gas, and a fuel gas discharge passage (not shown) for discharging the fuel gas.

The second separator 22 has an oxygen-containing gas flow field 32 on its surface facing the second gas diffusion layer 28b. The oxygen-containing gas flow field 32 is connected to an oxygen-containing gas supply passage (not shown) for supplying an oxygen-containing gas, and connected to an oxygen-containing gas discharge passage (not shown) for discharging the oxygen-containing gas.

When a plurality of the power generation cells 12 are stacked together, a coolant flow field 34 is formed between a surface of the first separator 20 and a surface of the second separator 22 which face each other. The coolant flow field 34 is connected to a coolant supply passage (not shown) for supplying a coolant and a coolant discharge passage (not shown) for discharging the coolant.

Next, the activation apparatus 10 will be described. The activation apparatus 10 includes a gas supply unit 40, a voltage application unit 42, and a temperature regulating unit 44 as main components. The gas supply unit 40 includes a first supply unit 40a for supplying an anode gas to the anode 26 through the fuel gas flow field 30, and a second supply unit 40b for supplying a cathode gas to the cathode 28 through the oxygen-containing gas flow field 32.

The first supply unit 40a can regulate the flow rate of the supplied anode gas, and mix water vapor with the anode gas to regulate the dew point of the anode gas. Likewise, the second supply unit 40b can regulate the flow rate of the supplied cathode gas, and mix water vapor with the cathode gas to regulate the dew point of the cathode gas.

As described later, examples of the anode gas include a hydrogen gas, an inert gas such as a nitrogen gas, a mixed gas of the hydrogen gas and the inert gas, and a humidified gas comprising any of these gases containing water vapor. Examples of the cathode gas include an inert gas such as a nitrogen gas, and a humidified gas comprising the inert gas containing water vapor. It should be noted that not only the humidified gas, but also each of the hydrogen gas, the inert gas, and the mixed gas may contain water vapor. The anode gas and the cathode gas may also be referred to as the gas, collectively.

The voltage application unit 42 applies cyclic voltage which is increased and decreased within a predetermined range, to the stack 14 through the first separator 20 provided at one end of the stack 14 in the stacking direction and the second separator 22 provided at another end of the stack 14 in the stacking direction. Specifically, the voltage application unit 42 includes a potentiostat 46 for applying voltage to the stack 14, and a potential sweeper 48 for controlling the voltage applied by the potentiostat 46.

In the structure, the voltage application unit 42 can arbitrarily adjust the range of the voltage to be applied to the stack 14, and the speed of changing the voltage. Stated otherwise, the voltage application unit 42 can change the applied voltage over time, and repeat the changes over time under control which is similar to that of potential sweep in the cyclic voltammetry.

The temperature regulating unit 44 supplies heat transmission medium regulated at a predetermined temperature to the coolant flow field 34 to regulate the temperature of the stack 14. By adopting the temperature regulating unit 44 to have the above structure, it is possible to effectively and easily regulate the temperature of the entire stack 14 using the existing structure of the stack 14.

The temperature regulating unit 44 is not limited to the above structure as long as the temperature regulating unit 44 can regulate the temperature of the stack 14. For example, the temperature regulating unit 44 may have a heater (not shown) capable of heating the stack 14.

Further, the gas supply unit 40 and the temperature regulating unit 44 may circulate the anode gas, the cathode gas, and the heat transmission medium to/from the stack 14 or supply the heat transmission medium to flow along the stack 14 internally (hermetically inside the stack 14) or flow through the stack 14 and discharge it without circulation.

The activation apparatus 10 according to the embodiment of the present invention basically has the above structure. Next, a method of activating the fuel cell according to the embodiment of the present invention, using the activation apparatus 10 will be described (hereinafter also simply referred to as the activation method).

In the embodiment of the present invention, the activation process is applied to the stack 14 immediately after assembling the stack 14. For this purpose, firstly, the voltage application unit 42 is electrically connected to the stack 14. The first supply unit 40a is connected to the fuel gas flow field 30, the second supply unit 40b is connected to the oxygen-containing gas flow field 32, the temperature regulating unit 44 is connected to the coolant flow field 34, and the stack 14 is set to the activation apparatus 10.

Next, a voltage application step is performed. In the voltage application step, the first supply unit 40a supplies a hydrogen gas to the anode 26, and the second supply unit 40b supplies an inert gas to the cathode 28. Further, the voltage application unit 42 applies cyclic voltage which is increased and decreased cyclically within the predetermined range to the stack 14.

That is, the gas supply unit 40 supplies a hydrogen gas as the anode gas, and supplies an inert gas as the cathode gas during a voltage application period in which the voltage is applied by the voltage application unit 42.

In this manner, it is possible to remove adhered materials such as residual solvent (carbon functional group) and oxide films adhered to the surface of the electrode catalyst contained in the cathode 28 and the anode 26, and clean these surfaces. Since this voltage application step can be performed in the same manner as described in Japanese Laid-Open Patent Publication No. 2013-038032, the detailed description is omitted.

As described above, in the voltage application step for supplying the inert gas to the cathode 28, it is possible to clean the surface of the electrode catalyst without inducing power generation reaction. Therefore, for example, in comparison with the case where the stack 14 is activated by supplying the oxygen-containing gas to the cathode 28 to induce power generation reaction, it is possible to reduce the consumed quantity of the gas, and simplify the required equipment.

Further, in the voltage application step, since the above power generation reaction does not occur, the quantity of heat produced in the stack 14 is small. Therefore, the temperature regulating unit 44 may regulate the temperature of the stack 14 up to a temperature where the above cleaning in the voltage application step can be facilitated. Further, since no water is produced during power generation reaction, preferably, in order to avoid the electrolyte membrane 24 from being dried, the gas supply unit 40 should be operated to allow at least one of the hydrogen gas and the inert gas to contain water vapor.

Further, in this regard, preferably, the temperature of the stack 14 and the dew points of the gases should be regulated in order to achieve the relationship where both of flooding in the stack 14 and drying of the electrolyte membrane 24 are suppressed. Flooding herein means, for example, the presence of excessive water in the liquid state in the stack 14 to a degree where supply of the gases is obstructed by the excessive water.

In this regard, intra-stack relative humidity is defined by an equation (saturated water vapor amount at the dew point of the anode gas or the cathode gas)/(saturated water vapor amount at the temperature of the stack 14)×100=intra-stack relative humidity (%)(equation 1). In this case, for example, by regulating the intra-stack relative humidity to about 100%, it becomes possible to satisfy the above relationship. In this manner, by regulating the temperature of the stack 14 and the dew points of the gases to suppress flooding, it is possible to prevent the voltage from being applied to the entire stack 14 non-uniformly. Therefore, it becomes possible to suitably clean the electrode catalyst in the entire stack 14. Further, by suppressing drying of the electrolyte membrane 24, it is possible to eliminate the concern of damage, etc. which could occur in the electrolyte membrane 24.

Preferably, the voltage application unit 42 applies the voltage in a range between 0.08 V and 1.00 V to the stack 14. By adopting the applied voltage of 0.08 V or more, in the voltage application step, it becomes possible to repeatedly induce reactions where hydrogen is adsorbed on, and removed from the electrode catalyst (catalyst metal). Accordingly, it becomes possible to effectively clean the surface of the electrode catalyst to a greater extent. Further, by adopting the applied voltage of 1.00 V or less, even in the case where the electrode catalyst includes a carbon catalyst support, it becomes possible to avoid degradation of the catalyst support.

Preferably, the number of cycles the voltage is applied to the stack 14 by the voltage application unit 42 (period in which the voltage application step is performed) may be determined in consideration of appearance of a peak as a sign indicating that the surface of the electrode catalyst is sufficiently cleaned, in a voltage-current change curve (not shown) obtained by application of the voltage. Examples of such a peak include a reduction peak which appears between 0.8 V and 0.6 V at the time of decreasing the voltage. By stopping application of the voltage by the voltage application unit 42 after appearance of the reduction peak, more preferably, after the elapse of a predetermined period from appearance of the reduction peak, it is possible to perform the voltage application step appropriately without any excess or shortage.

For example, in the voltage application step, the voltage is increased from 0.08 V to 1.00 V for a period of 45 seconds, and thereafter, the voltage is decreased from 1.00 V to 0.08 V for a period of 45 seconds. Assuming that one cycle is made up of these periods, it is preferable to repeat this cycle 20 or more times, i.e., perform the voltage application step for 30 minutes (0.50 hours) or more. In this manner, materials adhered to the surface of the electrode catalyst are removed sufficiently, and it becomes possible to achieve the sufficient magnitude of a Q (coulomb) value as an indicator value indicating the effective area of the electrode catalyst.

Next, application of the voltage by the voltage application unit 42 is stopped, and the gas supply unit 40 performs the humidifying step of supplying a humidified gas containing water vapor to at least one of the anode 26 and the cathode 28. That is, after the voltage application period, i.e., after the voltage application unit 42 stops application of the voltage, the gas supply unit 40 supplies the humidified gas as one of the anode gas and the cathode gas. It should be noted that the type of the humidified gas is not limited as long as the humidified gas does not have the nature of poisoning the electrode catalyst. Various gases may be adopted as the humidified gas.

The surface of the electrode catalyst is cleaned in the voltage application step, before performing the humidifying step. Therefore, it is possible to suitably supply water to the electrode catalyst surface without being obstructed by the adhered materials. As described above, by supplying water to the surface of the electrode catalyst, it is possible to facilitate reaction which occurs in the surface of the electrode catalyst.

Further, since the humidified gas reaches the electrolyte membrane 24 through the porous anode 26 and the porous cathode 28, the water is supplied to the electrolyte membrane 24, and the electrolyte membrane 24 is placed in a humidified state. As a result, it is possible to realize the desired proton conductivity of the electrolyte membrane 24. Also in this respect, it becomes possible to effectively activate the stack 14 to a greater extent.

Further, in order to obtain the above effect and advantages more effectively, for example, in the humidifying step, water vapor contained in the humidified gas is condensed inside the stack 14, and the water is effectively supplied to the surface of the electrolyte catalyst and/or the electrolyte membrane 24. As described above, in the humidifying step, in order to allow the water inside the stack 14 to be condensed easily, preferably, the temperature regulating unit 44 and the gas supply unit 40 regulate the dew point of the humidified gas to become higher than the temperature of the stack 14.

Further, the temperature regulating unit 44 may regulate the temperature of the stack 14 in the humidifying step to become equal to or lower than the temperature of the stack 14 in the voltage application step. Accordingly, it is possible to increase the intra-stack relative humidity in the humidifying step to become higher than the intra-stack relative humidity in the voltage application step. As a result, there is no need to regulate the dew point of the humidified gas by the gas supply unit 40 highly accurately. In the voltage application step, the water condensation does not occur easily inside the stack 14, and it is possible to suppress flooding inside the stack 14. Further, in the humidifying step, water condensation occurs easily inside the stack 14, and it becomes possible to effectively supply water to the electrode catalyst, etc.

In the humidifying step, the first supply unit 40a may supply a humidified gas having the same dew point as that of the hydrogen gas supplied to the anode 26 in the voltage application step, to the anode 26 in the humidifying step. Likewise, in the humidifying step, the second supply unit 40b may supply an inert gas having the same dew point as that of the inert gas supplied to the cathode 28 in the voltage application step, to the cathode 28 in the humidifying step. The meaning of the expression “the same” dew point herein may include “substantially the same” dew point. In this manner, since there is no need to provide the step of regulating the dew points of the gases supplied to at least one of the anode 26 and the cathode 28 between the voltage application step and the humidifying step, it is possible to efficiently activate the stack 14.

Further, in the humidifying step, as the humidified gases, if the hydrogen gas is supplied to the anode 26 and the inert gas is supplied to the cathode 28, since the same gases can be used in both of the voltage application step and the humidifying step, it is possible to improve the efficiency of activating the stack 14 to a greater extent.

Further, in this case, also in the humidifying step, it is possible to produce the potential difference between the anode 26 to which the hydrogen gas is supplied and the cathode 28 to which the inert gas is supplied. Also in this case, it becomes possible to effectively activate the stack 14 to a greater extent. As described above, a mixed gas of the hydrogen gas and the inert gas may be supplied to the anode 26, in order to produce a potential difference between the anode 26 and the cathode 28, reduce the quantity of the hydrogen gas supplied to the anode 26, and reduce the cost required for activation of the stack 14.

Preferably, in the humidifying step, the dew point of the cathode gas is regulated to become higher than the dew point of the anode gas. After the stack 14 is activated as described above, the stack 14 is handled in the state where the water inside the stack 14 has been purged. The anode gas and the cathode gas may be regulated to have low dew points, and used as purge gases for purging the water.

That is, the hydrogen gas as the purge gas is supplied to the anode 26, and the inert gas which is inexpensively handled in comparison with the hydrogen gas can be supplied as the purge gas to the cathode 28. Thus, after increasing the dew point of the cathode gas, and a large volume of the condensed water is distributed within the stack 14 on the cathode 28 side for activating the stack 14, a large volume of purge gas is supplied from the cathode 28 to perform purging. In this manner, it becomes possible to achieve cost reduction.

The present invention is not limited particularly to the above described embodiment. Various modifications can be made without deviating from the gist of the present invention.

### EMBODIMENT EXAMPLES

### Embodiment Example 1

### (1) Voltage Application Step

A stack 14 was assembled by stacking ten power generation cells 12 each having an MEA 18 with an effective power generation area of 100 cm². This stack 14 was set to the activation apparatus 10, and the voltage application step was performed. In the voltage application step, the temperature of the stack 14 was regulated to 80° C. by the temperature regulating unit 44. Further, by the first supply unit 40a, a hydrogen gas as the anode gas having the dew point of 75° C. was supplied to the anode 26 at the flow rate of 5 NL/min., and by the second supply unit 40b, a nitrogen gas as the cathode gas having the dew point of 80° C. was supplied to the cathode 28 at the flow rate of 20 NL/min.

Thereafter, after it was confirmed that the average cell potential of the cathode 28 becomes substantially constant at 0.1 V, cyclic voltage which is increased or decreased within a range between 0.08 V and 1.00 V was applied to the stack 14. At this time, the voltage is increased from 0.08 V to 1.00 V for a period of 45 seconds. Thereafter, the voltage is decreased from 1.00 V to 0.08 V for a period of 45 seconds. One cycle is made up of these periods. This cycle was repeated 20 times. One cycle is 90 seconds. Therefore, the voltage application step was performed for 0.50 hours.

### (2) Humidifying Step

After the voltage application step was performed as described above in the section (1), in the state where application of the voltage by the voltage application unit 42 is stopped, a humidifying step was performed. In the humidifying step, the temperature of the stack 14 was regulated to 40° C. by the temperature regulating unit 44. Further, a hydrogen gas (humidified gas) as the anode gas having the dew point of 75° C. was supplied to the anode 26 at the flow rate of 10 NL/min. by the first supply unit 40a. Further, a nitrogen gas (humidified gas) as the cathode gas having the dew point of 80° C. was supplied to the cathode 28 at the flow rate of 20 NL/min. by the second supply unit 40b.

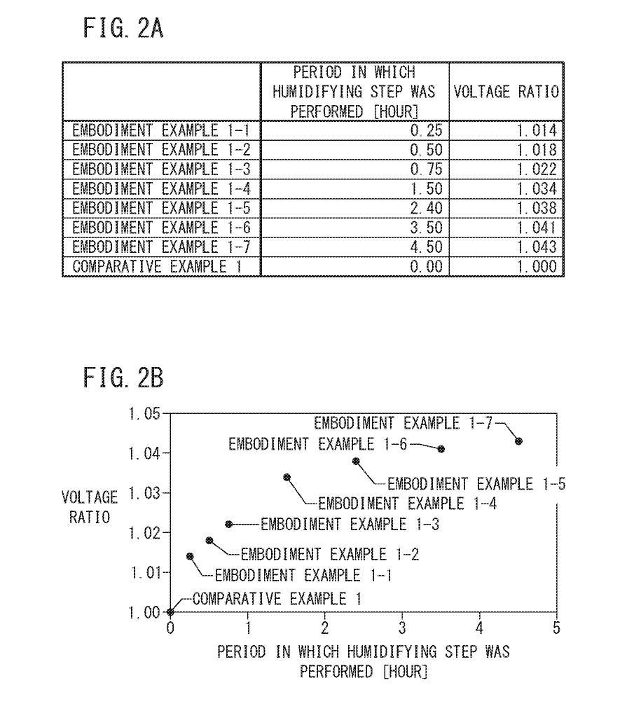

A period in which these states were maintained will be referred to as the period in which the humidifying step was performed. Stacks 14 according to a plurality of embodiment examples 1 were produced by adopting different periods in which the humidifying step was performed. Specifically, stacks 14 of the embodiment examples 1-1 to 1-7 were obtained under conditions of the periods in which the humidifying step was performed shown in FIG. 2A.

### Comparative Example 1

For comparison, a stack 14 of a comparative example 1 was produced by only performing the voltage application step as described above in the section (1) without performing the humidifying step. Stated otherwise, the humidifying period is 0.00 hour in the comparative example 1.

For each of the stacks 14 of the embodiment examples 1-1 to 1-7 and the comparative example 1, after water was purged, the average cell voltage of the stack 14 was determined. At this time, the output current density was 1.0 A/cm². The ratio of each of the average cell voltage of each of the stacks 14 of the embodiment examples 1-1 to 1-7 to the average cell voltage of the stack 14 of the comparative example 1 was calculated as the voltage ratio. That is, the voltage ratio of the stack 14 of the comparative example 1 was 1.000.

The result is shown in FIGS. 2A and 2B. FIG. 2A is a table showing periods in which a humidifying step was performed and voltage ratios, for stacks 14 of embodiment examples 1-1 to 1-7 and a comparative example 1. FIG. 2B is a graph where the period in which the humidifying step of FIG. 2A was performed is indicated by a horizontal axis, and the voltage ratio of FIG. 2A is indicated by a vertical axis.

As shown in FIGS. 2A and 2B, in all of the stacks 14 of the embodiment examples 1-1 to 1-7 where the humidifying step is performed after the voltage application step, the voltage ratio is larger than that of the stack 14 of the comparative example 1 where only the voltage application step is performed without performing the humidifying step. As can be seen from the above, it can be said that it is possible to improve the output of the stack 14, i.e., effectively activate the stack 14 by performing the humidifying step.

Further, it was found that, as the humidifying period gets longer, it becomes possible to increase the voltage ratio much more. As shown in FIG. 2B, the rise rate of the voltage ratio is high until the period in which the humidifying step was performed reaches 1.50 hours, and subsequently, the rise rate gets lower, and after the period in which the humidifying step was performed reaches 4.50 hours, the voltage ratio becomes substantially constant.

### Embodiment Example 2

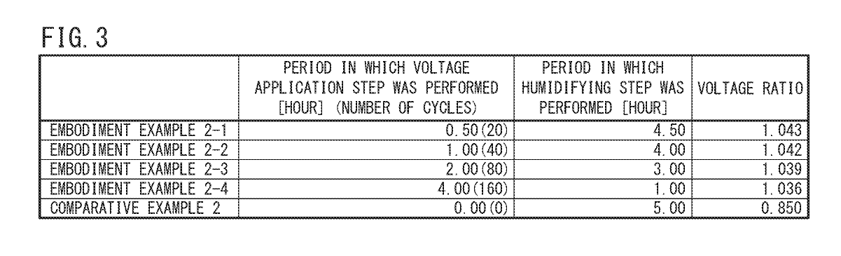

Stacks 14 according to the embodiment example 2 were produced in the same manner as the embodiment example 1 except that, the period in which the voltage application step was performed as described above in the section (1) and the period in which humidifying step was performed as described above in the section (2) were changed. Specifically, the stacks 14 of the embodiment examples 2-1 to 2-4 were obtained under conditions of the period in which the voltage application step was performed and the period in which the humidifying step was performed shown in FIG. 3. The embodiment example 2 was set up in a manner that the total time period of the period in which the voltage application step was performed and the period in which the humidifying step was performed was 5.00 hours, and the time allocation between these periods was changed.

### Comparative Example 2

For the purpose of comparison, a stack 14 of a comparative example 2 was obtained by performing only the humidifying step as described above in the section (2) for 5.00 hours, without performing the voltage application step.

For each of the stacks 14 of the embodiment examples 2-1 to 2-4 and the comparative example 2, the voltage ratio was calculated in the same manner as in the case of the embodiment example 1, and the result is shown in FIG. 3 as well.

As shown in FIG. 3, in all of the stacks 14 of the embodiment examples 2-1 to 2-4 where the humidifying step was performed after performing the voltage application step, the voltage ratio is large in comparison with the stack 14 of the comparative example 2 where the voltage application step was not performed.

As can be seen from the above, it can be said that it is not possible to sufficiently activate the stack 14 by the method which only supplies the humidified gas to the stack 14. In contrast, in the case where the surface of the electrode catalyst is cleaned by performing the voltage application step, and thereafter the humidifying step is performed, it is possible to suitably supply water to the surface of the electrode catalyst without being obstructed by the adhered materials. It was found that, in this manner, it is possible to effectively activate the stack 14.

### Embodiment Example 3

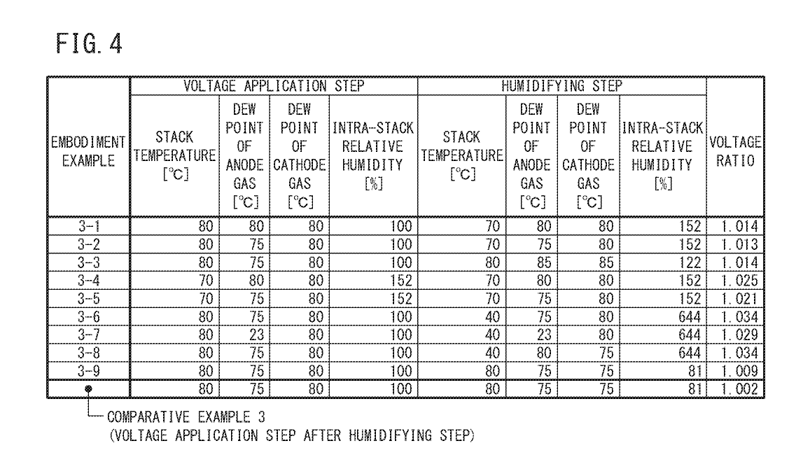

In the voltage application step as described above in the section (1), the flow rate of the anode gas was set to 10 NL/min., and the flow rate of the cathode gas was set to 40 NL/min. Further, the temperature of the stack 14 and the dew point of the anode gas were changed under the conditions shown in FIG. 4. Further, the period in which the humidifying step is performed as described above in the section (2) was set to 1.50 hours, the temperature of the stack 14, the dew point of the anode gas, and the dew point of the cathode gas were changed under the conditions shown in FIG. 4. In other respects, stacks 14 of the embodiment examples 3-1 to 3-9 were produced in the same manner as in the case of the embodiment example 1. These embodiments 3-1 to 3-9 will be referred to as the embodiment example 3, collectively.

### Comparative Example 3

For comparison, a stack 14 of a comparison example 3 was obtained under the same conditions as the embodiment example 3-9 except that the voltage application step was performed after performing the humidifying step, i.e., except that the order of performing the humidifying step and the voltage application step was changed.

For each of the stacks 14 of the embodiment examples 3-1 to 3-9 and the comparison example 3, the intra-stack relative humidity was calculated based on the above (equation 1) from the saturated water vapor amount at the higher one of the dew point of the anode gas and the dew point of the cathode gas, and the saturated water vapor amount at the temperature of the stack 14. Further, the voltage ratio was calculated in the same manner as in the case of the embodiment example 1, and the result is shown in FIG. 4 as well.

In the embodiment examples 3-4 and 3-5, in comparison with the other embodiment examples, the intra-stack relative humidity in the voltage application step is high. Therefore, in order to avoid the occurrence of the above flooding, the flow rate of the anode gas and the flow rate of the cathode gas in the voltage application step were increased.

As shown in FIG. 4, in all of the stacks 14 of the embodiment examples 3-1 to 3-9 in which the humidifying step was performed after performing the voltage application step, the voltage ratio is large in comparison with the stack 14 of the comparison example 3 in which the voltage application step was performed after performing the humidifying step. As can be seen from the above, in the method of performing the voltage application step after the humidifying step, it is difficult to sufficiently activate the stack 14. In contrast, it was found that, in the case where the humidifying step is performed after the voltage application step, as described above, it is possible to suitably supply water to the surface of the electrode catalyst, and effectively activate the stack 14.

In the stack 14 of the embodiment example 3-9 of FIG. 4, in the humidifying step, the dew points of the anode gas and the cathode gas (humidified gases) were regulated to become lower than the temperature of the stack 14. Also in this case, it can be said that the voltage ratio rate becomes not less than 1.000, and it is possible to effectively activate the stack 14. In contrast, in all of the stacks 14 of embodiment examples 3-1 to 3-8, in the humidifying step, the dew points of at least one of the anode gas and the cathode gas (humidified gases) were regulated to become not less than the temperature of the stack 14. It was found that, in this manner, it becomes possible to achieve the large voltage ratio which is larger than that of the stack 14 of the embodiment example 3-9, and it is possible to activate the stack 14 to a greater extent.

In all of the stacks 14 of the embodiment examples 3-1 to 3-9 of FIG. 4, the temperature of the stack 14 in the humidifying step was regulated to become equal to or lower than the temperature of stack 14 in the voltage application step. In this manner, it is possible to achieve the voltage ratio of not less than 1.000, and effectively activate the stack 14.

Stacks 14 of the embodiment example 3-2 and the embodiment example 3-6 were obtained under the same conditions except the temperature of the stack 14 in the humidifying step. That is, the temperature of the stack 14 in the humidifying step is 80° C. in both of the stack 14 of the embodiment example 3-2 and the embodiment example 3-6. As a result of comparison of these embodiment examples, in the stack 14 of the embodiment example 3-6 where the temperature of the stack 14 in the humidifying step is 40° C., the voltage ratio became about 2% larger than that of the stack 14 of the embodiment example 3-2 where the temperature of the stack 14 in the humidifying step is 70° C.

As can be seen from the above, by regulating the temperature of the stack 14 in the humidifying step to become significantly lower than the temperature of the stack 14 in the voltage application step to increase the quantity of condensed water produced in the stack 14 in the humidifying step, it is possible to effectively activate the stack 14 to a greater extent.

The stack 14 of the embodiment example 3-1 and the stack 14 of the embodiment example 3-4 in FIG. 4 were implemented under the same conditions except the temperature of the stack 14 and the flow rate of the anode gas and the flow rate of the cathode gas in the voltage application step. Likewise, the stack 14 of the embodiment example 3-2 and the stack 14 of the embodiment example 3-5 were implemented under the same conditions except the temperature of the stack 14 and the flow rate of the anode gas and the flow rate of the cathode gas in the voltage application step. According to comparison results of these embodiment examples, in comparison with the stacks 14 of the embodiment examples 3-1, 3-2, in the stacks 14 of the embodiment examples 3-4, 3-5 where the temperature of the stack 14 is low, and the flow rate of the anode gas and the flow rate of the cathode gas are large, the voltage ratio is large by about 1%.

As can be seen from the above, in the voltage application step, by satisfying at least one of the condition that the temperature of the stack 14 is low (intra-stack relative humidity is high) and the condition that the flow rate of the anode gas and the flow rate the cathode gas are large, it is possible to effectively activate the stack 14.

The stacks 14 of the embodiment example 3-6 and the embodiment example 3-7 of FIG. 4 were implemented under the same conditions except the dew point of the anode gas in each of the voltage application step and the humidifying step. As a result of comparison of these embodiment examples, it was found that the difference between the voltage ratio of the stack 14 of the embodiment example 3-6 and the voltage ratio of the stack 14 of the embodiment example 3-7 is about 0.5%. As can be seen from the above, in the voltage application step and the humidifying step, even in the embodiment example 3-7 where the dew point of the anode gas is significantly lower than that of the embodiment example 3-6, by sufficiently increasing the dew point of the cathode gas to maintain the intra-stack relative humidity, it is possible to activate the stack 14 sufficiently suitably.

Further, also in the stack 14 where the dew point of the cathode gas instead of the dew point of the anode gas is significantly low, by increasing the dew point of the anode gas to maintain the intra-stack relative humidity, the same result as in the case where the dew point of the cathode gas is low as described above was obtained.

Therefore, it can be said that, by supplying a gas having a sufficiently high dew point to one of the electrodes, i.e., the anode 26 or the cathode 28, it is possible to humidify the other electrode. Thus, it was found that, by supplying the humidified gas to at least one of the anode 26 and the cathode 28 in the humidifying step after the voltage application step, it is possible to suitably activate the stack 14.

Further, stacks 14 of the embodiment example 3-6 and the embodiment example 3-8 of FIG. 4 were obtained under the same conditions except the dew point of the anode gas and the dew point of the cathode gas in the humidifying step. Based on the result of comparison of these embodiment examples, it was found that the same voltage ratio was obtained in both of the cases, in the humidifying step, where the dew point of the anode gas is higher than the dew point of the cathode gas, and where the dew point of the cathode gas is higher than the dew point of the anode gas.

### Embodiment Example 4

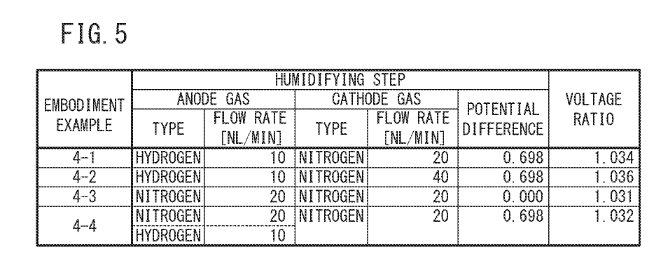

Stacks 14 of the embodiment examples 4 were produced in the same manner as in the case of the embodiment example 1 except that the type of the anode gas, the flow rate of the anode gas, and the flow rate of the cathode gas were changed in the humidifying step as described above in the section (2). Specifically, the stacks 14 of the embodiment examples 4-1 to 4-4 were obtained under the conditions shown in FIG. 5. For each of the stacks 14, the potential difference between the anode 26 to which the anode gas has been supplied and the cathode 28 to which the cathode gas has been supplied was determined. Further, the voltage ratio was calculated in the same manner as in the case of the embodiment example 1. The results are shown in FIG. 5 as well.

As can be seen from FIG. 5, in comparison with the embodiment example 4-1 where the flow rate of the cathode gas is 20 NL/min., in the embodiment example 4-2 where the flow rate of the cathode gas is 40 NL/min., the voltage ratio became slightly large.

As can be seen from FIG. 5, also in the stack 14 of the embodiment example 4-3 where the same nitrogen gas is used for both of the anode gas and the cathode gas, it is possible to achieve the sufficiently large voltage ratio. As described above, using the nitrogen gas for both of the anode gas and the cathode gas, it is possible to reduce the cost required for activation of the stack 14.

Further, as shown in FIG. 5, in the stack 14 of the embodiment example 4-3, the potential difference between the anode 26 and the cathode 28 is 0. In contrast, in the stacks 14 of the embodiment examples 4-1 and 4-2 where the hydrogen is used as the anode gas and the nitrogen is used as the cathode gas, the above potential difference is 0.698. As a result of comparison of these embodiment examples, it was found that the voltage ratios of the stack 14 of the embodiment examples 4-1 and 4-2 are slightly larger than the voltage ratio of the stack 14 of the embodiment example 4-3. As can be seen from the above, by supplying the hydrogen gas to the anode 26 and supplying the inert gas to the cathode 28 as the humidified gases to produce the above potential difference, it is possible to effectively activate the stack 14 to a greater extent.

Further, as shown in FIG. 5, also in the stack 14 of the embodiment example 4-4 where the mixed gas of the hydrogen gas and the nitrogen gas is used as the anode gas, the above potential difference is 0.698. It was found that the voltage ratio of the stack 14 of the embodiment example 4-4 also becomes slightly larger than the voltage ratio of the stack 14 of the embodiment example 4-3. As can be seen from the above, by supplying both of the hydrogen gas and the inert gas as the humidifying gases to the anode 26, to reduce the quantity of the hydrogen gas supplied to the anode 26, it becomes possible to achieve cost reduction, and effectively activate the stack 14.

What is claimed is:

1. A method of activating a fuel cell, the fuel cell comprising an electrolyte membrane of solid polymer, an anode provided on one surface of the electrolyte membrane, and a cathode provided on another surface of the electrolyte membrane,
the method comprising:
a voltage application step of applying cyclic voltage which is increased and decreased within a predetermined range, to the fuel cell while supplying a hydrogen gas to the anode and supplying an inert gas to the cathode; and
a humidifying step of supplying a humidified gas containing water vapor to at least one of the anode and the cathode after the voltage application step, in a state where application of the voltage is stopped.

2. The method of activating the fuel cell according to claim 1, wherein, in the humidifying step, a dew point of the humidified gas is regulated to become higher than a temperature of the fuel cell.

3. The method of activating the fuel cell according to claim 1, wherein a temperature of the fuel cell in the humidifying step is regulated to become equal to or lower than a temperature of the fuel cell in the voltage application step.

4. The method of activating the fuel cell according to claim 3, wherein the temperature of the fuel cell is regulated by supplying a heat transmission medium having a regulated temperature, to a coolant flow field provided for the fuel cell.

5. The method of activating the fuel cell according to claim 1, further comprising at least one of the steps of:
supplying the humidified gas having same dew point as that of the hydrogen gas supplied to the anode in the voltage application step, to the anode in the humidifying step; and
supplying the humidified gas having same dew point as that of the inert gas supplied to the cathode in the voltage application step, to the cathode in the humidifying step.

6. The method of activating the fuel cell according to claim 1, wherein in the humidifying step, as the humidified gases, the hydrogen gas is supplied to the anode and the inert gas is supplied to the cathode.

7. The method of activating the fuel cell according to claim 5, wherein in the humidifying step, as the humidified gases, both of the hydrogen gas and the inert gas are supplied to the anode.

8. The method of activating the fuel cell according to claim 1, wherein the fuel cell comprises a stack of a plurality of power generation cells stacked together.

9. An apparatus for activating a fuel cell, the fuel cell comprising an electrolyte membrane of solid polymer, an anode provided on one surface of the electrolyte membrane, and a cathode provided on another surface of the electrolyte membrane,
a gas supply unit configured to supply an anode gas to the anode, and supply a cathode gas to the cathode; and
a voltage application unit configured to apply cyclic voltage which is increased and decreased within a predetermined range, to the fuel cell,
wherein the gas supply unit is configured to supply a hydrogen gas as the anode gas, and supply an inert gas as the cathode gas, in a voltage application period in which the voltage is applied by the voltage application unit, and configured to supply a humidified gas containing water vapor as at least one of the anode gas and the cathode gas after the voltage application period, in a state where application of the voltage is stopped.

10. The apparatus for activating the fuel cell according to claim 9, wherein the gas supply unit is configured to supply the humidified gas having a dew point which is higher than a temperature of the fuel cell.

11. The apparatus for activating the fuel cell according to claim 9, further comprising a temperature regulating unit configured to regulate a temperature of the fuel cell,
wherein the temperature regulating unit is configured to regulate a temperature of the fuel cell after the voltage application period to become equal to or lower than a temperature of the fuel cell in the voltage application period.

12. The apparatus for activating the fuel cell according to claim 11, wherein the temperature regulating unit is configured to regulate the temperature of the fuel cell by supplying a heat transmission medium having a regulated temperature, to a coolant flow field provided for the fuel cell.

13. The apparatus for activating the fuel cell according to claim 9, wherein the gas supply unit is configured to perform at least one of:
supplying the humidified gas having same dew point as that of the hydrogen gas supplied to the anode in the voltage application period, to the anode after the voltage application period; and
supplying the humidified gas having same dew point as that of the inert gas supplied to the cathode in the voltage application period, to the cathode after the voltage application period.

14. The apparatus for activating the fuel cell according to claim 9, wherein the gas supply unit is configured to supply the hydrogen gas to the anode, and supply the inert gas to the cathode, as the humidified gases.

15. The apparatus for activating the fuel cell according to claim 9, wherein the gas supply unit is configured to supply both of the hydrogen gas and the inert gas to the anode, as the humidified gases.

16. The apparatus for activating the fuel cell according to claim 9, wherein the fuel cell comprises a stack of a plurality of power generation cells stacked together.
